(19) United States
(12) Patent Application Publication
(10) Pub. No.: US 2013/0133416 A1
(43) Pub. Date: May 30, 2013

(54) MEASURING DEVICE

(71) Applicant: Deere & Company, Moline, IL (US)

(72) Inventors: BERNHARD KNAPP, Waldboeckelheim (DE); Wolfgang Schraml, Ladenburg (DE)

(73) Assignee: Deere & Company, Moline, IL (US)

(21) Appl. No.: 13/658,391

(22) Filed: Oct. 23, 2012

(30) Foreign Application Priority Data
Nov. 29, 2011 (DE) 102011087358.9

(51) Int. Cl. G01F 23/14

(52) U.S. Cl. 73/168

(57) ABSTRACT

A fluid volume measuring device for use in a hydraulic system, includes a conduit element which holds hydraulic fluid, a transfer arrangement axially movably along a displacement path within the conduit element. A contact-free sensor is functionally connected with the transfer arrangement. The sensor detects a displacement of the transfer arrangement along the displacement path relative to the conduit element.

### FIELD

The present disclosure relates to a measuring device for a fluid volume for use in a hydraulic system.

### BACKGROUND

JP 2009 236615 A shows a device for detecting the filling level of oil in an oil tank. The device is located outside the tank. The device consists of a glass test tube, in which a magnetic float is carried by an oil column in a test tube that is moving up and down. A sensor unit is placed on the circumference of the test tube, so as to detect the movement of the float. It would be desirable to have a fluid measuring device which, as in, for example, brake systems, measures the volumes of a fluid under pressure, flowing in a limited time period.

### SUMMARY

According to an aspect of the present disclosure, a fluid volume measuring device is provided for use in a hydraulic system. The device includes a conduit element which holds hydraulic fluid, a transfer arrangement, and a contact-free sensor. The transfer arrangement is movable axially along a displacement path within the conduit element. The sensor is functionally connected with the transfer arrangement, so as to detect a displacement of the transfer arrangement, along the displacement path, relative to the conduit element. The transfer arrangement subdivides the hydraulic fluid into two fluid columns, so as to transfer a work pressure between the two fluid columns.

By means of this device, it is possible for a volume of a hydraulic fluid under pressure, flowing in a short period of time, to be measured in a conduit of a hydraulic system. For example, the device can be used in a hydraulic brake system which can be used for a validation of the brake valve or the brake piston. In particular, the volume can be measured during braking, wherein the volume flow does not need to be continuous during the braking and can approach zero toward the end of the braking.

In a preferred development, the transfer arrangement is sealed off, fluid-tight, with respect to the conduit element, along the displacement path of the transfer arrangement. In particular, the transfer arrangement is sealed off, fluid-tight, with respect to an inside surface of the conduit element. In this way, a high degree of measuring accuracy is ensured, in that the transfer arrangement moves completely with the fluid columns and fluid cannot be exchanged, along the transfer arrangement, between the two fluid columns.

In a concrete development, the transfer arrangement has a piston element and is sealed off, via the piston element, with respect to a cylindrical inside surface of the conduit element. It is hereby advantageous that the production of a piston-cylinder combination is feasible in a low-cost and simple manner. The cylindrical inside surface is preferably honed and the piston element is a cylinder roller.

The piston element is preferably sealed-off by means of a fit with respect to the cylindrical inside surface of the conduit element. This ensures that the piston element can move smoothly in the conduit element and no additional sealings need be provided. As a result of the smoothness of the movement, it is, in turn, ensured that no pressure gradient or almost no pressure gradient prevails between the two fluid columns into which the piston element subdivides the fluid.

Preferably, the transfer arrangement can be moved into an overflow position, so that the hydraulic fluid overflows via at least one groove in the conduit element. By means of the overflow position and the overflow of the fluid between the two fluid columns, which is possible in this position, a venting is ensured, or a blocking is prevented, for example, if the measuring device in accordance with the invention is located in a hydraulic brake. Preferably, several grooves, for example, three, are arranged over the circumference.

Preferably, an overflow position is provided at least on one end of the displacement path. This ensures that a venting can take place or a blocking is avoided of a hydraulic brake, into which the brake [sic; device] in accordance with the invention can be inserted.

In a concrete development, the conduit element has a connecting member for insertion into a hydraulic system—at least on one axial end—in which the at least one groove is located so that it runs in the longitudinal direction. The connecting member is preferably designed as closing caps. The connecting member can be connected with the conduit element, on one side, and with a hydraulic conduit, on the other side. In this way, the at least one longitudinal groove can be milled into the connecting member, in a simple manner with regard to manufacturing technology, which are constructed, in particular, as a closing cap.

Preferably, the contact-free sensor is a magnetostrictive sensor. In this way, a measurement can take place from outside the conduit element, so that no additional sealing surface is required between the sensor and the conduit element.

Preferably, the transfer arrangement comprises a magnetized element. It is advantageous hereby for the transfer arrangement to be composed of two components, wherein the magnetic element, which, as a first component, is preferably designed as a magnet, assumes a measuring function, and the piston element, as the second component, assumes a sealing function.

Preferably, the sensor is placed at a distance to the conduit element. In this way, a high measuring accuracy is also ensured with a different magnetization of the magnetized element.

Preferably, the magnetized element has a middle borehole running in an axial direction, via which the magnetized element is maintained, centered, on a cylinder stud of a piston element of the transfer arrangement. It is advantageous for the affixing of the magnetized element with respect to the piston element to be realized in a simple manufacturing-technical manner. In particular, the cylinder stud can be produced by turning the piston element.

In a concrete development, the magnetized element is a ring magnet. It is advantageous for it to be a standard part which already simultaneously has a middle borehole to hold the cylinder stud of the piston element.

### BRIEF DESCRIPTION OF THE DRAWINGS

FIG. 1 is a longitudinal sectional view through the measuring device in accordance with the invention; and

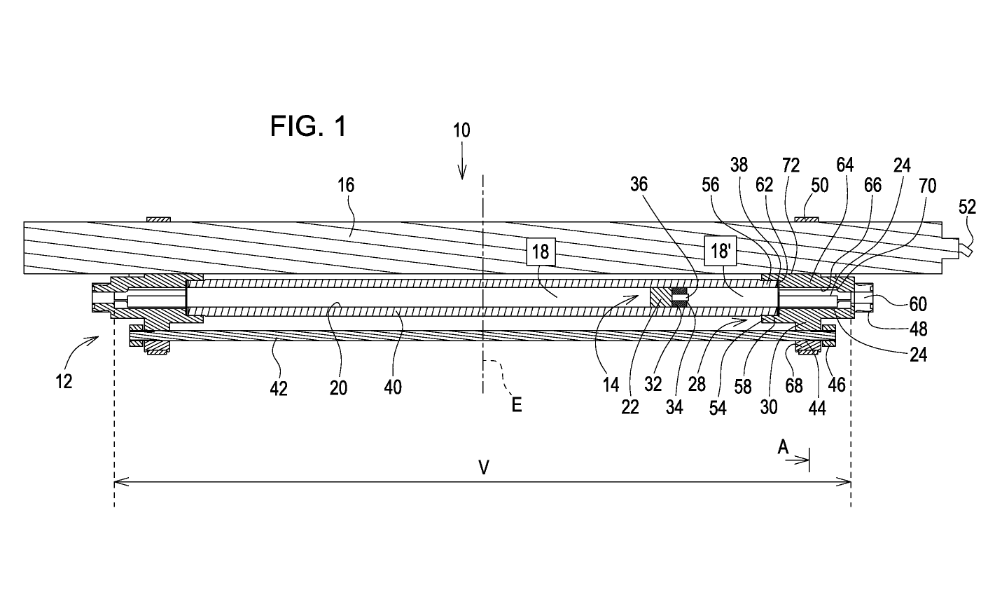

FIG. 2 is a sectional view along the section line A-A in FIG. 1.

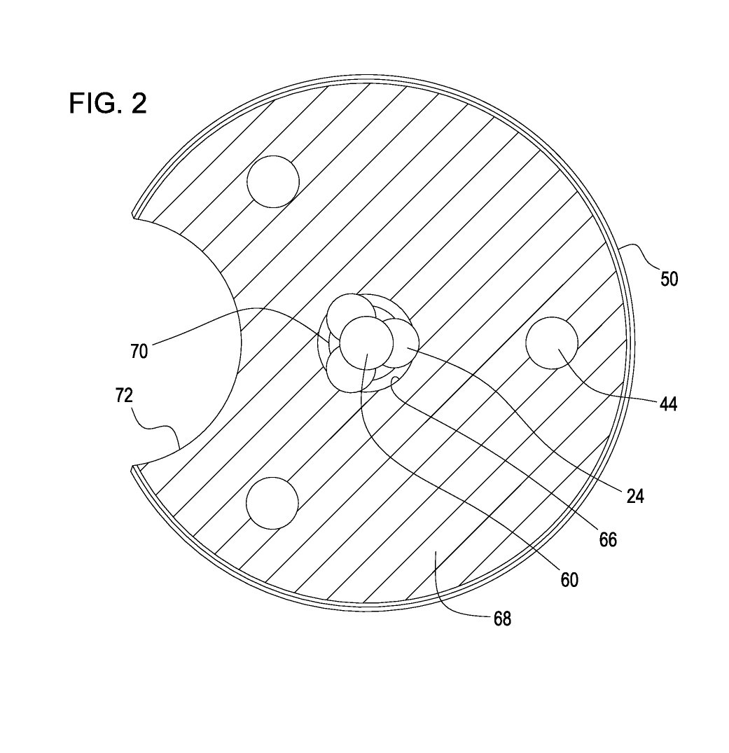

### DETAILED DESCRIPTION OF THE DRAWINGS

The figures show a measuring device 10, consisting of a conduit element 12 and a contact-free, non-contact or contactless sensor 16. The measuring device 10 is constructed in an essentially symmetrical manner, with the exception of the transfer arrangement 14 regarding a cross-sectional plane E. In this respect, an explicit description of doubly present device parts as a result of this symmetry is omitted.

The measuring device 10 can be inserted into a hydraulic system (not shown), for example, into a hydraulic brake system. After insertion of the measuring device 10 into a hydraulic system a venting, described further below, is required, so that accordingly, the conduit element 12 receives a throughflow of a hydraulic fluid, and the transfer arrangement 14 subdivides the hydraulic fluid, in accordance with the invention, into two fluid columns, for the transfer of a work pressure.

The conduit element 12 and the sensor 16 are preferably arranged parallel to one another and affixed relative to one another. The conduit element 12 comprises a cylinder tube 40 with a cylindrical inside surface 20. A transfer arrangement 14 can be moved in the axial direction inside the cylinder tube 40. The transfer arrangement 14 consists, in this embodiment, of a piston element 22, which forms a cylinder stud 36 toward one axial side, and a magnetized element 32 in the form of a ring magnet. The ring magnet has a middle borehole 34, by means of which the ring magnet is stuck on the cylinder stud 36 of the piston element 22. The sealing between the cylindrical inside surface 20 of the cylinder tube 40 and the piston element 22 is carried out by means of an implemented fit, which is preferably a 12F7 fit. Preferably, the cylindrical inside surface 20 of the cylinder tube 40 is honed.

The sensor 16 is a magnetostrictive position sensor, which, in a contact-free manner, recognizes the position of the magnetized element 32 in the cylinder tube 40 of the conduit element 12. A position sensor in the configuration suitable for this embodiment example of the invention is traditionally known and, for example, can be obtained as a Micropulse Type from the Balluff Company.

The conduit element 12 also comprises connecting member 30, in the form of closing caps, on both axial ends. The connecting members 30 are clamped against one another by means of spacer bolts 42 and nuts 46 so that the cylinder tube 40 is wedged in or clamped between the connecting member 30. To this end, the connecting member 30 have a collar 68, in which, distributed over the circumference and uniformly distanced, axial boreholes 44 are provided. The spacer bolts 42 project through the axial boreholes 44 and are clamped by means of the nuts 46 on the back. The cylinder tube 40, the piston element 22, and the connecting member 30, and perhaps other individual parts of the measuring device 10 are made of a nonmagnetizable material, preferably, stainless steel 1.4301.

Furthermore, the collar 68 has a radial recess 72 to hold the sensor 16. The recess 72 is at least partially circular and in its diameter, corresponds to the outside diameter of the sensor 16. The affixing of the sensor 16, held in the individual recess 72 of the connecting member 30, is preferably carried out by means of a hose clip 50. Preferably, the diameter of the collar 68 and the depth or the diameter of the recess 72 are hereby selected, relative to one another, in such a way that a gap of approximately 4 mm is maintained between the sensor 16 and the cylinder tube 40.

A sealing ring 38, example, a copper ring, seals between the cylinder tube 40 and the individual connecting members 30. Each connecting member 30 has a first cylindrical section 54, with which the closing cap is moved onto a corresponding band section 56 with a cylindrical outside circumferential surface 58 of the cylinder tube 40, before a clamping takes place by means of the spacer bolts 42 and nuts 46.

On the facing away from the cylinder tube 40, the connecting member 30 forms a connecting thread 48 to connect a hydraulic conduit, for example a hydraulic brake system. The connecting thread 48 is preferably an outside thread in the form of a dash-6 screw connection. To conduct hydraulic fluid through, the connecting member 30 has a middle passage borehole 60. The first cylindrical section 54 goes over, along a shoulder 62, into a second cylindrical section 64 with a cylindrical inside surface 66 with a smaller diameter. The diameter of the cylindrical inside surface 66 is preferably minimally larger than the diameter of the cylindrical inside surface 20 of cylinder tube 40. The transfer arrangement 14 can thus move, from the cylinder tube 40, on both axial sides of the conduit element 12, to the second cylindrical sections 64 of the connecting member 30, along a displacement path V.

On the ends of its displacement path V, the transfer arrangement 14 assumes an overflow position, in which, via three grooves 24, which are distributed over the circumference in the cylindrical inside surface 66 of the second cylindrical section 64, the hydraulic fluid can flow past the transfer arrangement 14. A number of grooves 24 that are different from three can also be provided, for example, two diametrically opposed grooves 24. In the overflow position, the transfer arrangement 14 fits closely, with its side pointing in the flow direction, on a shoulder 70, which forms the transition from the cylindrical inside surface 66 of the second cylindrical section 64 to the passage borehole 60. The grooves continue in the axial direction, beyond the shoulder 70, into the passage borehole 60. If the transfer arrangement 14 is located in the overflow position, the measuring device 10 can be vented, if it is inserted into a hydraulic system. Furthermore, the overflow position ensures that even with a complete displacement of the transfer arrangement 14, along the displacement path V, hydraulic fluid, for example, of a hydraulic brake, can continue to flow from a brake valve to a wheel-side brake piston.

This measuring device 10 detects fluid volumes which are small and under pressure. During the measurement, the piston element 22 in the cylinder 40 is displaced and detected by the contact-free sensor 16 via the magnetized element 32, coupled with the piston element 22. The displaced volume of the fluid can be deduced via the known cross-sectional area of the cylinder tube 40.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1. A fluid volume measuring device for use in a hydraulic system, the measuring device having a conduit element which holds the fluid of the hydraulic system, a transfer arrangement movable axially within the conduit element along a displacement path and a contactless sensor which is functionally connected with the transfer arrangement and which detects a displacement of the transfer arrangement relative to the conduit element, characterized in that:
the transfer arrangement divides the hydraulic fluid into two fluid columns and transfers a work pressure between the two fluid columns.

2. The measuring device of claim 1, wherein:
the transfer arrangement is sealed off, fluid-tight, relative to the conduit element, along the displacement path of the transfer arrangement.

3. The measuring device of claim 1, wherein:
the transfer arrangement has a piston element which sealingly engages a cylindrical inside surface of the conduit element.

4. The measuring device of claim 3, wherein:
the piston element is fitted relative to the cylindrical inside surface of the conduit element.

5. The measuring device of one of claim 1, wherein:
the transfer arrangement is movable into an overflow position wherein the hydraulic fluid overflows through a groove in the conduit element.

6. The measuring device of claim 5, wherein:
the overflow position is provided at one end of the displacement path.

7. The measuring device of claim 5, wherein:
the conduit element has connecting member on at least one axial end for inserting into a hydraulic system, and the one groove runs in the longitudinal direction and is located in the connecting member.

8. The measuring device of claim 1, wherein:
contactless sensor is a magnetostrictive sensor.

9. The measuring device of claim 1, wherein:
the transfer arrangement comprises a magnetized element.

10. The measuring device of claim 1, wherein:
the sensor (16) is located at a distance to the conduit element.

11. The measuring device of claim 10, wherein:
the magnetized element has an axially extending middle borehole; and
the piston element includes a cylinder stud which is received by the borehole.

12. The measuring of claim 9, wherein:
the magnetized element is a ring magnet.
